(19) United States
(12) Patent Application Publication
(10) Pub. No.: US 2019/0091707 A1
(43) Pub. Date: Mar. 28, 2019

(54) ELECTROSTATIC SPRAY APPARATUS

(71) Applicant: ANEST IWATA Corporation, Kanagawa (JP)

(72) Inventors: Kazuaki SATO, Kanagawa (JP); Shoji KAKIZAKI, Kanagawa (JP)

(21) Appl. No.: 16/087,865

(22) PCT Filed: Mar. 22, 2017
(86) PCT No.: PCT/JP2017/011312

§ 371 Date: Sep. 24, 2018

(30) Foreign Application Priority Data
Mar. 25, 2016 (JP) 2016-062471
Mar. 9, 2017 (JP) 2017-044550

(51) Int. Cl. B05B 5/053; B05B 12/16

(52) U.S. Cl. CPC B05B 5/0533; B05B 12/16

(57) ABSTRACT

An electrostatic spray apparatus includes: a voltage application device; a liquid spraying section including a nozzle for spraying a liquid a charged state by utilizing an electrostatic force generated by the voltage application device; and a coating prevention electrode for generating an electric field between the coating prevention electrode and a portion of the object to be coated on which the liquid is not to be coated. The voltage application device applies a voltage such that, when a potential of the object to be coated is a reference potential, a potential of the liquid spraying section assumes a first potential different from the reference potential, and a potential of the coating prevention electrode assumes a second potential. The second potential is a potential different from the reference potential, and a direction of polarity of the second potential is to the same as a direction of polarity of the first potential.

### TECHNICAL FIELD

The present invention relates to an electrostatic spray apparatus.

### BACKGROUND ART

Conventionally, a thin film forming apparatus is disclosed which includes a nozzle and a mask. The nozzle is configured to spray a solution material in a state where a voltage is applied to the solution material. The mask is disposed in the vicinity of a substrate between the nozzle and the substrate, and includes an opening portion having a predetermined opening pattern (see PTL 1). In the thin film forming apparatus, the solution material sprayed from the nozzle is deposited on the substrate as a thin film. A portion of the opening portion of the mask on the nozzle side is configured to have a larger opening area than a portion of the opening portion of the mask on the substrate side.

### CITATION LIST

### Patent Literature

PTL 1: Japanese Patent Laid-Open No. 2014-147891

### SUMMARY OF INVENTION

### Technical Problem

Objects to be coated on which a liquid, such as paint, is to be coated may have a variety of shapes. Further, the objects to be coated having the same shape may differ from each other in a portion on which liquid coating is not desired. If a mask is prepared for each instance according to the shape of the object to be coated or a liquid coating region, costs are increased. Moreover, an operation of disposing the mask on the object to be coated is required before a liquid coating operation is performed, thus requiring time and effort.

It is an object of the present invention to provide an electrostatic spray apparatus which can avoid a liquid being coated on a portion of an object to be coated on which liquid coating is not desired while suppressing an increase in cost, time, or effort.

### Solution to Problem

(1) An electrostatic spray apparatus according to one aspect of the present invention, which causes a liquid to be coated on an object to be coated, includes: a voltage application device; a liquid spraying section which includes a nozzle for causing the liquid to leave in a charged state by utilizing an electrostatic force generated by the voltage application device; and a coating prevention electrode configured to generate an electric field between the coating prevention electrode and a portion of the object to be coated on which the liquid is not to be coated. The voltage application device is configured to apply a voltage such that, when a potential of the object to be coated is a reference potential, a potential of the liquid spraying section assumes a first potential which is different from the reference potential, and a potential of the coating prevention electrode assumes a second potential. The second potential is a potential which is different from the reference potential, and a direction of polarity of the second potential is equal to a direction of polarity of the first potential.

(2) In the aspect of the above-mentioned (1), the coating prevention electrode is positioned on a side opposite to the liquid spraying section with respect to an imaginary plane which is orthogonal to a straight line connecting a distal end of the nozzle and the object to be coated with each other with a shortest distance, at a point where the straight line intersects the object to be coated.

(3) In the aspect of the above-mentioned (1) or (2), the coating prevention electrode is a rod member which is made of a conductive material or a semi-conductive material.

(4) In the aspect of any one of the above-mentioned (1) to (3), the coating prevention electrode is positioned on a side opposite to the liquid spraying section with respect to the object to be coated.

(5) In the aspect of any one of the above-mentioned (1) to (4), the voltage application device applies a voltage between the object to be coated and the liquid spraying section, and between the object to be coated and the coating prevention electrode.

(6) In the aspect of any one of the above-mentioned (1) to (5), the first potential and the second potential are approximately equal to each other.

(7) In the aspect of any one of the above-mentioned (1) to (6), the electrostatic spray apparatus includes a proximity electrode disposed in a vicinity of the nozzle. The voltage application device is configured to apply a voltage such that a potential of the proximity electrode assumes a third potential between the reference potential and the first potential. The third potential is set such that a potential difference between the first potential and the third potential assumes a potential difference which allows generation of an electrostatic force by which the liquid is caused to leave from the nozzle in a charged state.

According to the aspect of the present invention, it is possible to provide an electrostatic spray apparatus which can avoid a liquid being coated on a portion of an object to be coated on which liquid coating is not desired while suppressing an increase in cost, time, or effort.

### BRIEF DESCRIPTION OF DRAWINGS

FIG. 1 is a perspective view of an electrostatic spray apparatus according to a first embodiment of the present invention.

FIG. 2 is a cross-sectional view of the electrostatic spray apparatus according to the first embodiment of the present invention.

FIG. 3 is a cross-sectional view showing only a liquid spraying section in the first embodiment of the present invention.

FIG. 4A is an enlarged cross-sectional view of the distal end side of the liquid spraying section shown in FIG. 2.

FIG. 4B is an enlarged cross-sectional view of the distal end side of the liquid spraying section shown in FIG. 2.

FIG. 5 is a side view showing a state of an electric field in the first embodiment of the present invention.

FIG. 6 is a perspective view of an electrostatic spray apparatus according to a second embodiment of the present invention.

FIG. 7 is a top plan view showing a state of an electric field in the second embodiment of the present invention.

FIG. 8 is a perspective view of an electrostatic spray apparatus according to a third embodiment of the present invention.

FIG. 9 is a perspective view of an electrostatic spray apparatus according to a fourth embodiment of the present invention.

### DESCRIPTION OF EMBODIMENTS

Hereinafter, embodiments for carrying out the present invention (hereinafter referred to as embodiments) are described in detail with reference to attached drawings. Identical elements are given the same numbers throughout the entire description of the embodiments.

Unless otherwise specified, expressions such as “distal (end)” or “front (side)” indicate the side, in each member or the like, to which the liquid is sprayed, and expressions such as “rear (end)” or “rear (side)” indicate the side, in each member or the like, opposite to the direction in which the liquid is sprayed.

### First Embodiment

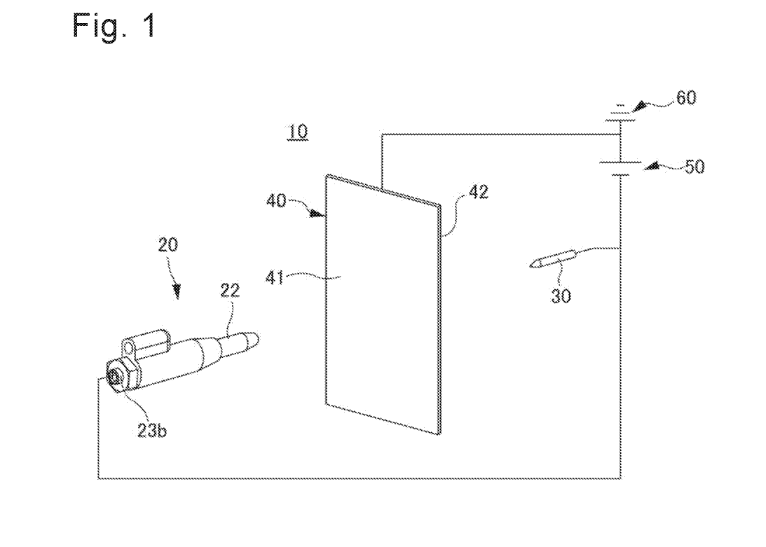

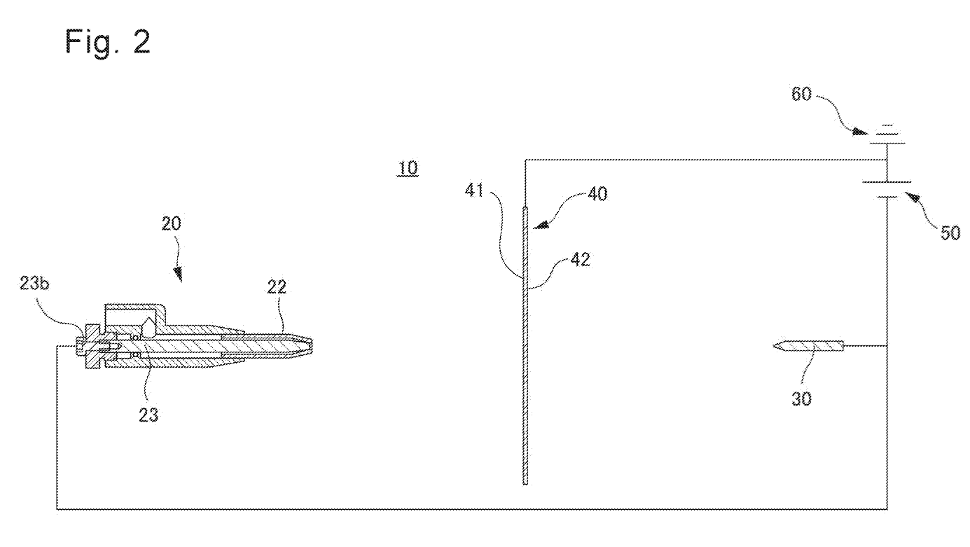

FIG. 1 is a perspective view of an electrostatic spray apparatus 10 according to a first embodiment of the present invention. FIG. 2 is a cross-sectional view of the electrostatic spray apparatus 10 taken along a center axis of a liquid spraying section 20.

As shown in FIG. 1 and FIG. 2, the electrostatic spray apparatus 10 includes the liquid spraying section 20, a coating prevention electrode 30, and a voltage application device 50 (voltage power source). The liquid spraying section 20 includes a nozzle 22 disposed so as to face a front surface 41 of a flat plate-shaped object to be coated 40. The front surface 41 is a portion of the object to be coated 40 on which a liquid is to be coated. The coating prevention electrode 30 is disposed so as to be directed to a rear surface 42 of the object to be coated 40. The rear surface 42 is a portion of the object to be coated 40 on which the liquid is not to be coated. The coating prevention electrode 30 is a rod member which is made of a conductive material or a semi-conductive material. The voltage application device 50 applies a voltage between the object to be coated 40 and the liquid spraying section 20, and between the object to be coated 40 and the coating prevention electrode 30. The semi-conductive material means a material having a surface resistance of equal to or less than 10¹⁰Ω, for example.

In this embodiment, the voltage application device 50 is described as one voltage power source. However, the voltage application device 50 is not necessarily formed of one voltage power source. For example, the voltage application device 50 may include one power supply voltage which applies a voltage between the object to be coated 40 and the liquid spraying section 20, and one voltage power source which applies a voltage between the object to be coated 40 and the coating prevention electrode 30. That is, the voltage application device 50 may include two power supply voltages in total.

In this embodiment, an electric wire from the voltage application device 50 is directly connected to the object to be coated 40. However, the electric wire from the voltage application device 50 may be connected to a terminal provided to a placement table or the like on which the object to be coated 40 is to be placed. In this case, when the object to be coated 40 is placed on the placement table or the like, the object to be coated 40 comes into contact with the terminal so that the object to be coated 40 is electrically connected to the voltage application device 50.

The electrostatic spray apparatus 10 also includes a ground wire 60 connected to the electric wire which extends from the voltage application device 50, and which is connected to the object to be coated 40. With such a configuration, the object to be coated 40 is grounded. An operator may come into contact with the object to be coated 40, and thus it is preferable to provide the ground wire 60 so as to ground the object to be coated 40 from the viewpoint of safety. However, the ground wire 60 is not essential.

(Liquid Spraying Section)

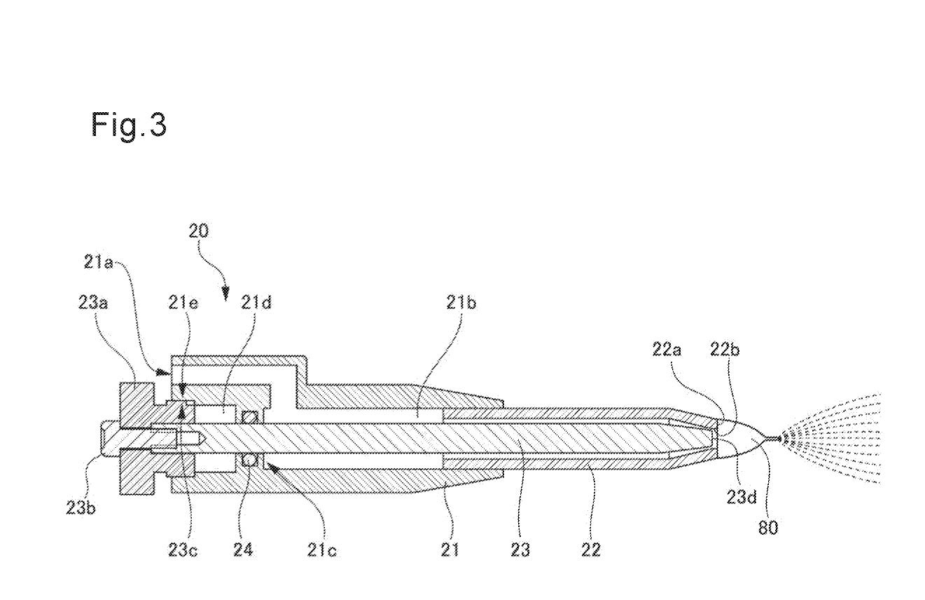

FIG. 3 is a cross-sectional view showing only the liquid spraying section 20, and FIG. 3 also shows a state where a liquid, such as paint, is being sprayed from the liquid spraying section 20 as described later.

As shown in FIG. 3, the liquid spraying section 20 includes a body portion 21 made of an insulating material, the nozzle 22, and a central rod 23 made of a conductive material. A liquid flow passage 21b is formed in the body portion 21. The liquid flow passage 21b has a liquid supply port 21a through which a liquid is supplied into the body portion 21. The nozzle 22 is provided to a distal end of the body portion 21. A through hole is formed inside the nozzle 22, and the through hole communicates with the liquid flow passage 21b of the body portion 21. The central rod 23 is disposed in the liquid flow passage 21b of the body portion 21 and in the through hole of the nozzle 22.

A hole portion 21c is provided in the body portion 21 to remove the central rod 23 to the rear end side. The hole portion 21c communicates with the liquid flow passage 21b. A sealing member 24 is provided in the hole portion 21c. The sealing member 24 is provided for sealing a gap formed between the body portion 21 and the central rod 23 thus preventing leakage of the liquid. In this embodiment, an O-ring is used as the sealing member 24. However, the sealing member 24 is not limited to the O-ring, and may be any sealing member which can seal the gap.

A knob portion 23a and an electric wire connecting portion 23b are provided at a rear end of the central rod 23, which end is located on the rear end side of the body portion 21 through the hole portion 21c. The knob portion 23a is made of an insulating material. The electric wire connecting portion 23b is provided to penetrate approximately the center of the knob portion 23a. The electric wire connecting portion 23b is made of a conductive material.

As shown in FIG. 2, an electric wire from the voltage application device 50 is connected to the electric wire connecting portion 23b. Contact of the electric wire connecting portion 23b with the central rod 23 allows electrical connection between the central rod 23 and the electric wire connecting portion 23b.

In this embodiment, the central rod 23 is used as an electrode on the liquid spraying section 20 side. However, the nozzle 22 may be used as an electrode on the liquid spraying section 20 side. In this case, for example, the nozzle 22 of the liquid spraying section 20 may be made of a conductive material, and the electric wire from the voltage application device 50 may be connected to the nozzle 22.

As shown in FIG. 3, a female thread structure 21e is provided on an inner peripheral surface of a rear end opening portion 21d of the body portion 21. The knob portion 23a is threadedly engaged with the female thread structure 21e. On the other hand, a male thread structure 23c is provided on an outer peripheral surface of a distal end of the knob portion 23a.

With such a configuration, the male thread structure 23c, provided on the outer peripheral surface of the distal end of the knob portion 23a, is threadedly engaged with the female thread structure 21e of the rear end opening portion 21d of the body portion 21, thus mounting the central rod 23 on the body portion 21 in a removable manner. Adjusting an amount of threaded engagement of the knob portion 23a allows the central rod 23 to be moved in a longitudinal direction, and also allows the position of a distal end surface 23d of the central rod 23 to be adjusted in the longitudinal direction.

In general, a nozzle, which sprays a liquid, of an electrostatic spray apparatus has a fine liquid flow passage which has a through hole, through which a liquid flows, and which has a small diameter. The reason why the through hole has a small diameter may be because if a distal end of the nozzle, from which the liquid flows out, has a large opening diameter, a stable atomized state of the liquid may not be acquired. For example, in general, the opening diameter at the distal end of the nozzle is set to 0.1 mm or less.

Accordingly, if the liquid dries, an opening portion at a distal end of the nozzle immediately becomes clogged. In this case, there is a problem that it is difficult to clear such clogging due to its small opening diameter.

However, although the reason will be described later, the applicant of the present application has found that with the use of the central rod 23, even if the distal end of the nozzle has a large opening diameter, more favorable atomization can be achieved compared to the conventional technique. Accordingly, an opening portion 22b at a distal end of the nozzle 22 in this embodiment has a large opening diameter of 0.2 mm. As a result, a frequency of occurrence of clogging can be significantly reduced.

The opening diameter of the opening portion 22b of the nozzle 22 is not limited to 0.2 mm. In the aspect which uses the central rod 23, the opening diameter may be set to approximately 1.0 mm without causing any problems.

To prevent clogging from easily occurring, or to allow the opening portion 22b to be cleaned even when clogging occurs, the opening diameter of the opening portion 22b of the nozzle 22 is preferably set to a value equal to or greater than 0.1 mm, is more preferably set to a value equal to or greater than 0.2 mm, and is further preferably set to a value greater than 0.2 mm.

On the other hand, to stabilize atomization, the opening diameter of the opening portion 22b of the nozzle 22 is preferably set to a value equal to or less than 1.0 mm, is more preferably set to a value equal to or less than 0.8 mm, and is further preferably set to a value equal to or less than 0.5 mm.

Further, in this embodiment, as described above, the central rod 23 is movable in the longitudinal direction. Accordingly, even if clogging occurs, clogging can be cleared by moving the central rod 23. Further, an inner diameter of the through hole of the nozzle 22 is large enough to dispose the central rod 23 in the through hole. Therefore, the opening portion 22b can be cleaned by removing the central rod 23 and by making a large amount of cleaning solution flow through the nozzle.

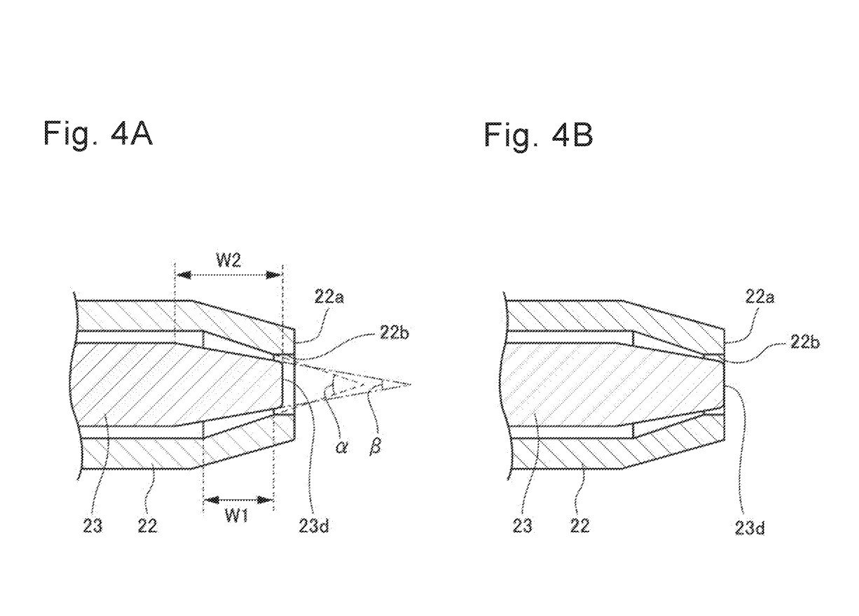

FIG. 4A and FIG. 4B are enlarged views showing the distal end side of the liquid spraying section 20 in an enlarged manner. FIG. 4A shows a state where the distal end surface 23d of the central rod 23 is positioned rearward. FIG. 4B shows a state where the distal end surface 23d of the central rod 23 is positioned more forward compared to the state shown in FIG. 4A.

As shown in FIG. 4A, the nozzle 22 has a tapered inner diameter portion where an inner diameter decreases so as to have a tapered shape toward the opening portion 22b side (see a range W1). The central rod 23 has a tapered portion where an outer diameter decreases toward the distal end surface 23d (see a range W2).

The taper angle of the tapered inner diameter portion is set to α. The taper angle of the tapered portion is set to β. The taper angle α of the tapered inner diameter portion of the nozzle 22 is larger than the taper angle β of the tapered portion of the central rod 23. Further, the diameter of the distal end surface 23d of the central rod 23 is set smaller than the opening diameter of the opening portion 22b of the nozzle 22. However, the tapered portion of the central rod 23 is formed such that the diameter of the tapered portion gradually increases toward the rear end side, and that the tapered portion has a portion having a diameter larger than the opening diameter of the opening portion 22b of the nozzle 22.

The distal ends of the nozzle 22 and the central rod 23 are formed as described above. Accordingly, as can be understood by comparing FIG. 4A and FIG. 4B from each other, the width of a gap formed between the nozzle 22 and the central rod 23 can be adjusted by moving the central rod 23 in the longitudinal direction. As a result, the amount of liquid discharged from the opening portion 22b of the nozzle 22 can be adjusted.

By moving the central rod 23 further forward from the state shown in FIG. 4B, the central rod 23 comes into contact with an inner peripheral surface of the nozzle 22, thus allowing the opening portion 22b of the nozzle 22 to be closed. Accordingly, in a state where a liquid, such as paint, is not sprayed, closing the opening portion 22b of the nozzle 22 by the central rod 23 can prevent the liquid in the nozzle 22 from drying. As a result, clogging of the nozzle 22 can be suppressed.

Next, with reference to FIG. 3, the description is first made with respect to the state where a liquid is sprayed from the liquid spraying section 20. Thereafter, the description is made with respect to a technique where a liquid is coated on the front surface 41, which is a portion of the object to be coated 40 on which the liquid is to be coated, while preventing the liquid from being coated on the rear surface 42, which is a portion of the object to be coated 40 on which the liquid is not to be coated.

The liquid supplied to the liquid supply port 21a of the body portion 21 is supplied to the distal end side of the nozzle 22. Then, by an electrostatic force generated by applying a voltage between the object to be coated 40 and the central rod 23 with the voltage application device 50 (see FIG. 1 and FIG. 2), the liquid is drawn forward, thus leaving forward and being atomized.

To be more specific, the voltage application device 50 applies a voltage such that, when the potential of the object to be coated 40 is a reference potential (the reference potential is 0 V since the object to be coated 40 is grounded in this embodiment), the potential of the liquid spraying section 20 (more accurately, the potential of the central rod 23) assumes a first potential which is different from the reference potential. The first potential is set such that a potential difference between the reference potential and the first potential assumes a potential difference which allows generation of an electrostatic force by which the liquid is caused to leave from the nozzle 22 in a charged state. Accordingly, the liquid supplied to the distal end side of the nozzle 22 is drawn forward by the electrostatic force, thus leaving forward and being atomized.

It is sufficient to sequentially supply a liquid by an amount corresponding to an amount of liquid which is consumed through the liquid spraying section 20 by being sprayed. In other words, it is not necessary to pressure-feed the liquid under pressure to cause the liquid to be ejected from the opening portion 22b of the nozzle 22 (more accurately, a gap formed between the opening portion 22b and the central rod 23). When the liquid is strongly ejected, the liquid may conversely not be properly atomized.

To more specifically describe such a state where the liquid leaves and is atomized, an electrostatic force which draws the liquid forward is balanced with the surface tension of the liquid with respect to the distal end surface 23d of the central rod 23 and the distal end edge portion 22a of the nozzle 22, and with the adhesive force of the liquid due to viscosity. Accordingly, as shown in FIG. 3, a Taylor cone 80 is formed where the liquid supplied to the distal end side of the nozzle 22 is formed into a conical shape at a distal end of the nozzle 22.

The Taylor cone 80 is formed as follows. Separation of positive/negative charges occurs within the liquid due to the action of the electric field so that a meniscus at the distal end of the nozzle 22, which is charged with excessive charge, deforms and is formed into a conical shape. The liquid is drawn in a straight line from a distal end of the Taylor cone 80 by an electrostatic force and, thereafter, the liquid is sprayed due to electrostatic explosion.

The liquid to be sprayed, that is, the liquid leaving from the nozzle 22 and formed into liquid particles, remarkably increases an area exposed to air compared to the state before the liquid leaves the nozzle 22. Accordingly, vaporization of the solvent is promoted. With vaporization of the solvent, the distance between charged electrons decreases, thus causing electrostatic repulsion (electrostatic explosion). As a result, liquid particles are divided into liquid particles having a smaller particle size.

When such division occurs, the liquid particles increase a surface area exposed to air compared to a surface area before the division. Accordingly, vaporization of the solvent is promoted, thus causing the electrostatic explosion in the same manner as above. As a result, the liquid particles are divided into liquid particles having a smaller particle size. Such electrostatic explosion is repeated, thus atomizing the liquid.

In this embodiment, the central rod 23 is provided in the nozzle 22. Assume that the central rod 23 is not provided as in the case of the conventional electrostatic spray apparatus. In such a case, the portion to which a liquid is allowed to adhere is limited to the distal end edge portion 22a of the nozzle 22.

If the opening diameter of the opening portion 22b of the nozzle 22 is increased in such a state, the portion, to which the liquid is allowed to adhere, is limited to the distal end edge portion 22a of the nozzle 22 and hence, for example, the liquid may easily waver upward, downward, leftward or rightward of the nozzle 22, or the Taylor cone 80 having an optimal shape may not be formed. Further, in some cases, the Taylor cone 80 per se may not be maintained. The reason is inferred as follows. The liquid particles leaving from the nozzle 22 cannot acquire stability (stability in size, number, charged state and the like of particles) and, as a result, stable atomization of the liquid may not be achieved.

On the other hand, in this embodiment, the central rod 23 is disposed in the nozzle 22 so that the liquid adheres not only to the distal end edge portion 22a of the nozzle 22 but also to the distal end surface 23d of the central rod 23. Accordingly, it is considered as follows. Even if the opening portion 22b of the nozzle 22 has a large opening diameter, the distal end surface 23d of the central rod 23, to which the liquid is allowed to adhere, is present at the center portion of the opening portion 22b. Therefore, the Taylor cone 80 can be formed in a stable manner, thus enabling the liquid to be atomized in a stable manner.

When the distal end surface 23d of the central rod 23 excessively projects forward from the distal end edge portion 22a of the nozzle 22 (that is, a distal end surface of the opening portion 22b of the nozzle 22), the electric field is prevented from easily acting on the liquid discharging from the nozzle 22. On the other hand, when the distal end surface 23d of the central rod 23 excessively retracts rearward from the distal end surface of the opening portion 22b of the nozzle 22, a state occurs which is substantially equal to a state where a portion to which a liquid is allowed to adhere is not present at a center portion of the opening portion 22b.

In view of the above, in spraying a liquid, it is preferable to set the position of the distal end surface 23d of the central rod 23 at a certain position. That is, using the distal end surface of the opening portion 22b of the nozzle 22 as a reference, in the longitudinal direction along the center axis of the central rod 23, it is preferable to set the distal end surface 23d of the central rod 23 at the position within ten times as large as the opening diameter of the opening portion 22b at the distal end of the nozzle 22. It is more preferable to set the distal end surface 23d at the position within five times as large as the opening diameter of the opening portion 22b, and it is further preferable to set the distal end surface 23d at the position within three times as large as the opening diameter of the opening portion 22b.

For example, in this embodiment, the opening diameter of the opening portion 22b of the nozzle 22 is set to 0.2 mm. Accordingly, when an electrostatic force does not act on the liquid, the liquid is discharged from the opening portion 22b of the nozzle 22 while being formed into a semispherical shape having a diameter of approximately 0.2 mm at the distal end of the nozzle 22.

To allow the electric field (electrostatic force) to act on the liquid discharged from the distal end of the nozzle 22 so as to form the Taylor cone 80 having a conical shape, it is desirable that the distal end of the central rod 23 be present at a position close to the liquid reaching to an area close to the opening portion 22b of the nozzle 22. Accordingly, it is preferable to set the distal end of the central rod 23 at the position within 2 mm in the forward direction (in the direction along which the distal end of the central rod 23 projects) from the distal end surface of the opening portion 22b of the nozzle 22. On the other hand, to allow the electric field to act for the adhesion of the liquid, it is desirable to set the distal end of the central rod 23 at the position within 2 mm in the rearward direction (in the direction along which the distal end of the central rod 23 retracts) from the distal end surface of the opening portion 22b of the nozzle 22.

Providing the central rod 23 as described above enables stable atomization of the liquid even in a state where the opening diameter of the opening portion 22b of the nozzle 22 is increased. Accordingly, the opening diameter of the opening portion 22b of the nozzle 22 can be set to a large opening diameter which can suppress clogging. Further, the opening diameter of the opening portion 22b of the nozzle 22 can be increased, thus enabling the nozzle 22 to be easily manufactured by machining.

In this embodiment, the distal end surface 23d at the distal end of the central rod 23 is formed into a flat planar surface. However, the distal end surface 23d is not necessarily formed into a flat planar surface. It is sufficient for the distal end surface 23d to have a shape which can contribute to stable formation of the Taylor cone 80. For example, the distal end surface 23d may be formed into a curved surface which projects forward.

The liquid which is sprayed from the liquid spraying section 20 (the nozzle 22) as described above repeats electrostatic explosion, thus being formed into fine particles. The liquid which is formed into fine particles is in a charged state and hence, the liquid is attracted, by an electrostatic force, toward the object to be coated 40 which acts as a pole having a polarity different from a polarity of the liquid spraying section 20 by the voltage application device 50. Accordingly, the liquid is coated on the object to be coated 40.

As described above, in the electrostatic spray apparatus 10 of this embodiment, as shown in FIG. 1 and FIG. 2, the coating prevention electrode 30 is disposed so as to be directed to the rear surface 42, which is a portion of the object to be coated 40 on which the liquid is not to be coated.

As shown in FIG. 1 and FIG. 2, an electric wire, which is directly branched from the electric wire connecting the voltage application device 50 and the liquid spraying section 20 with each other, is connected to the coating prevention electrode 30. Accordingly, when the potential of the object to be coated 40 is a reference potential, the coating prevention electrode 30 has a second potential which is different from the reference potential in the same manner as the liquid spraying section 20. Further, the direction of polarity of the second potential is to the same as the direction of polarity of the first potential which the liquid spraying section 20 has.

In this embodiment, the electric wire, which is directly branched from the electric wire connecting the voltage application device 50 and the liquid spraying section 20 with each other, is connected to the coating prevention electrode 30 without interposing a resistance or the like therebetween. Accordingly, the first potential of the liquid spraying section 20 and the second potential of the coating prevention electrode 30 are approximately equal to each other.

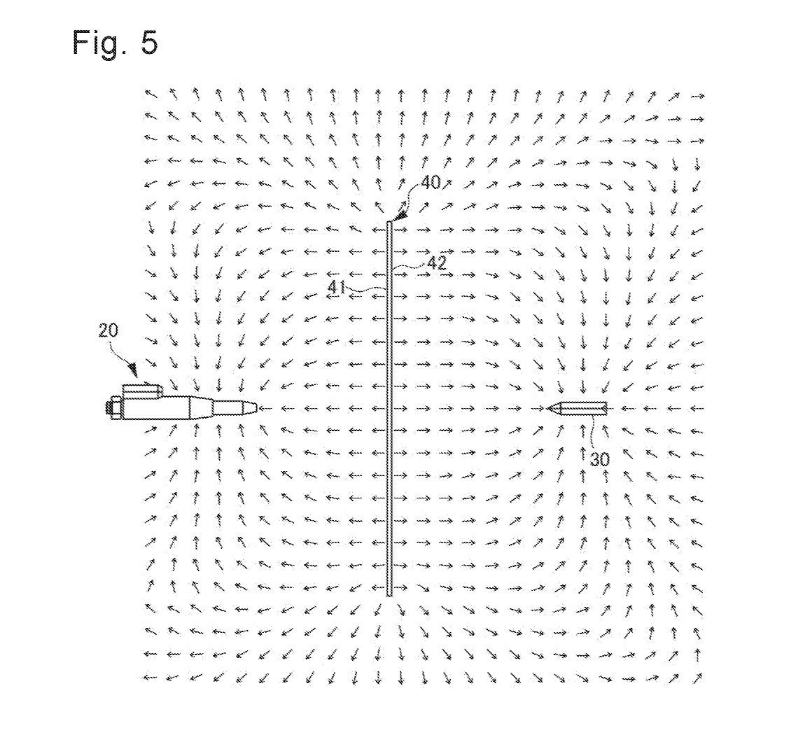

FIG. 5 is a view showing a state of the electric field (the direction of the electric field) when the voltage application device 50 applies a voltage between the object to be coated 40 and the liquid spraying section 20, and between the object to be coated 40 and the coating prevention electrode 30. FIG. 5 is a side view as viewed from the direction from which a side surface of the liquid spraying section 20 can be observed. In FIG. 5, the illustration of the voltage application device 50 and the electric wires is omitted.

As can be understood from FIG. 5, on the rear surface 42 side of the object to be coated 40, an electric field generated between the object to be coated 40 and the coating prevention electrode 30 is present and hence, the electric field generated between the object to be coated 40 and the liquid spraying section 20 does not pass around to the rear surface 42 side. Also in a top plan view as viewed from the upper surface, a state of the electric field similar to the electric field shown in FIG. 5 is observed.

That is, the electric field between the liquid spraying section 20 and the object to be coated 40 is generated only between the liquid spraying section 20 and the front surface 41. Accordingly, the liquid sprayed from the liquid spraying section 20 is, without passing around to the rear surface 42 side of the object to be coated 40, attracted to the front surface 41 of the object to be coated 40, thus being coated on the front surface 41 of the object to be coated 40.

To the contrary, if the coating prevention electrode 30 is not provided, a state occurs where the electric field is also generated between the liquid spraying section 20 and the rear surface 42. Accordingly, of the liquid sprayed from the liquid spraying section 20, the liquid sprayed to a position offset from the object to be coated 40 passes around to the rear surface 42 side of the object to be coated 40, thus being coated on the rear surface 42. In the case of this embodiment, the occurrence of coating which passes around to the rear surface 42 side of the object to be coated 40 can be suppressed and hence, it is unnecessary to provide a mask on the rear surface 42 of the object to be coated 40.

### Second Embodiment

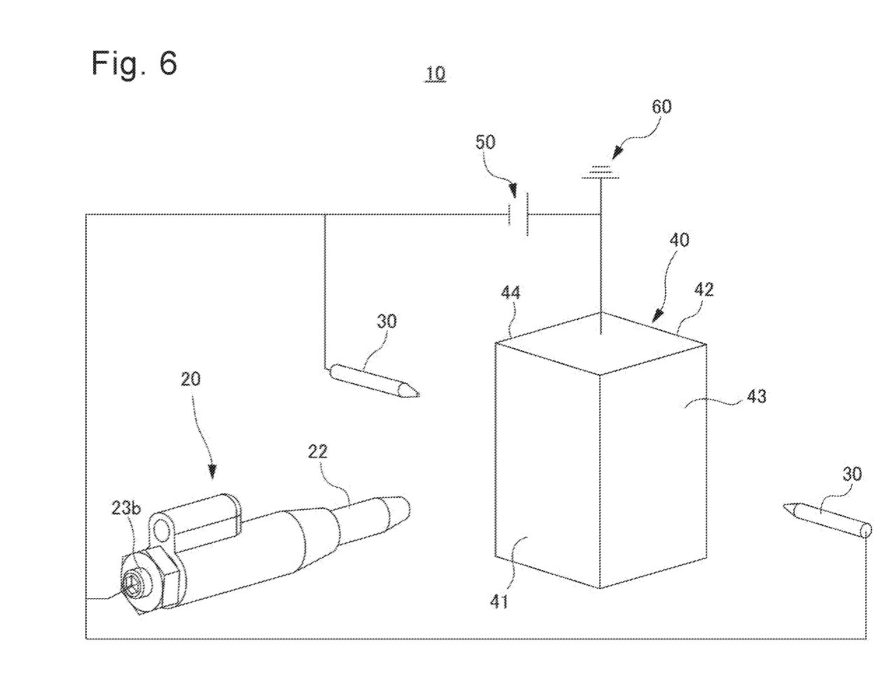

FIG. 6 is a perspective view showing an electrostatic spray apparatus 10 of a second embodiment. Most configurations of the electrostatic spray apparatus 10 of the second embodiment are similar to those in the first embodiment. Accordingly, hereinafter, points which make the second embodiment different from the first embodiment are mainly described, and the description of components in the second embodiment similar to those in the first embodiment may be omitted.

The second embodiment differs from the first embodiment in that an object to be coated 40 has a shape of a quadrangular prism. However, the second embodiment is similar to the first embodiment in that a liquid is to be coated on a front surface 41 of the object to be coated 40. The second embodiment also differs from the first embodiment in that a portion on which the liquid is not to be coated is not formed of a rear surface 42, but is mainly formed of left and right side surfaces 43, 44 and hence, two coating prevention electrodes 30 are disposed so as to be directed to the portions on which the liquid is not to be coated.

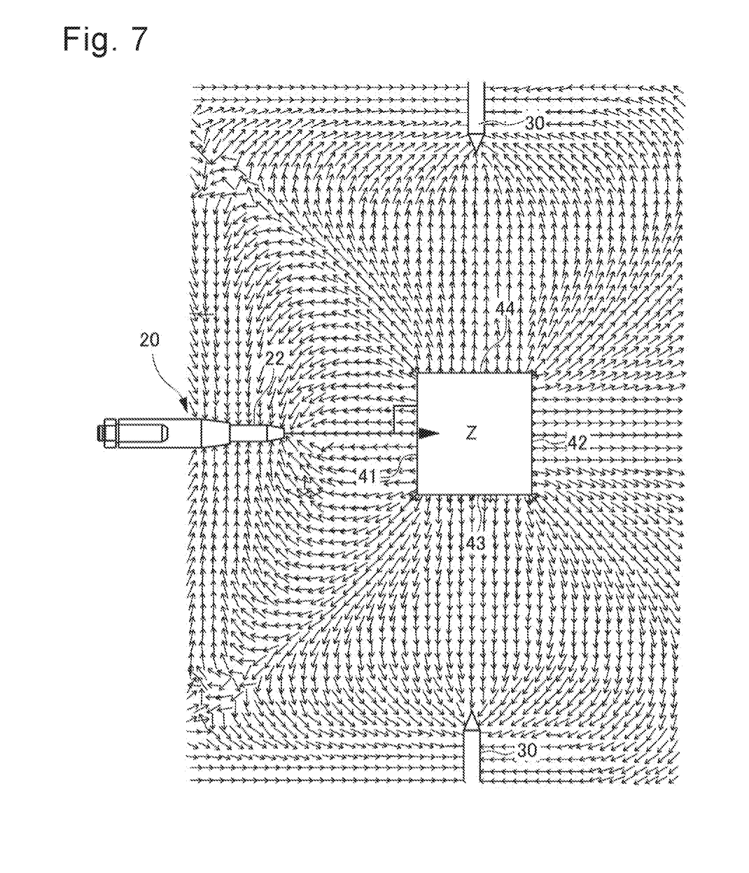

FIG. 7 is a view showing a state of the electric field (the direction of the electric field) when the voltage application device 50 applies a voltage between the object to be coated 40 and a liquid spraying section 20, and between the object to be coated 40 and the two coating prevention electrodes 30. FIG. 7 is a top plan view as viewed from the direction from which the upper side of the liquid spraying section 20 can be observed. In FIG. 7, the illustration of a voltage application device 50 and electric wires are omitted.

As can be understood from FIG. 7, also in this embodiment, the electric field is generated between the object to be coated 40 and the coating prevention electrodes 30. Accordingly, the electric field generated between the liquid spraying section 20 and the left and right side surfaces 43, 44 of the object to be coated 40, to which the coating prevention electrodes 30 are directed, does not pass around to the side surface 43, 44 side. Therefore, even if a mask is not provided on the left and right side surfaces 43, 44 of the object to be coated 40, the liquid sprayed from the liquid spraying section 20 is not coated on the left and right side surfaces 43, 44 of the object to be coated 40. If it is desired to also prevent the liquid from being coated on upper and lower surfaces of the object to be coated 40, an additional coating prevention electrodes 30 may also be provided so as to be directed to the upper and lower surfaces.

If it is desired to cause the liquid to be coated mainly on the front surface 41 of the object to be coated 40 as described above, it is preferable to position the coating prevention electrode 30 as follows. A planar surface (see the front surface 41) orthogonal to a straight line (see the Z axis in FIG. 7), which connects the distal end of a nozzle 22 and the object to be coated 40 with each other with a shortest distance, is defined at a point where the straight line (see the Z axis in FIG. 7) intersects the object to be coated 40. In such a case, the coating prevention electrode 30 is positioned at an appropriate position on the side opposite to the liquid spraying section 20 with respect to the planar surface (for example, at the position directed to any of the upper surface, the lower surface, the left surface, and the right surface of the object to be coated 40, or at the position directed to the rear surface 42 as in the case of the first embodiment).

Particularly, as in the case of the first embodiment, when the liquid is not to be coated on the rear surface 42 of the flat plate-shaped object to be coated 40, it is preferable to position the coating prevention electrode 30 on a side opposite to the liquid spraying section 20 with respect to the object to be coated 40.

### Third Embodiment

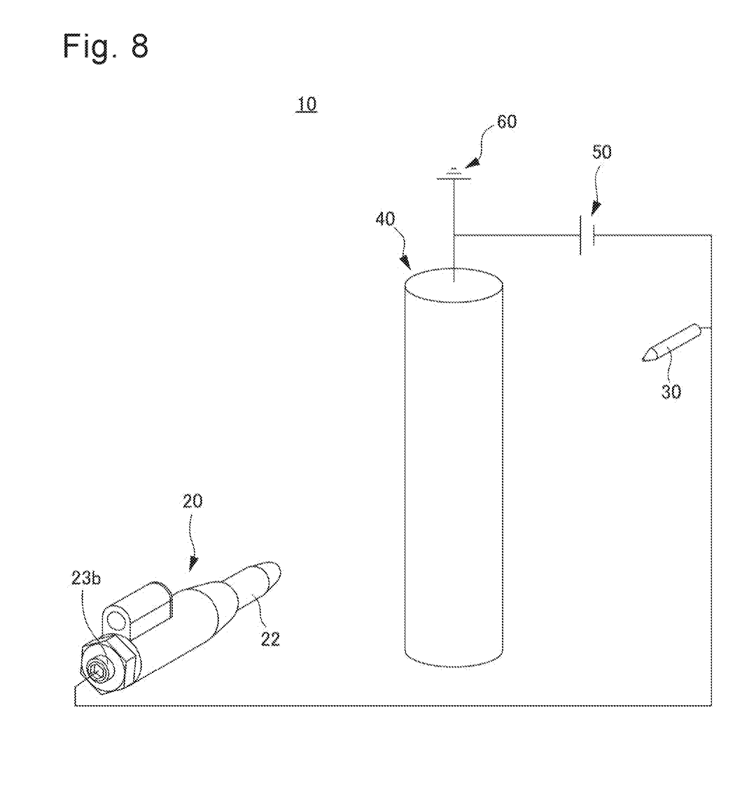

FIG. 8 is a perspective view showing an electrostatic spray apparatus 10 of a third embodiment. The third embodiment differs from the first embodiment in that a columnar object to be coated 40 is used instead of the flat plate-shaped object to be coated 40 in the first embodiment. Other configurations in the third embodiment are similar to the first embodiment. With such a configuration, a liquid can be coated on a half surface of the columnar object to be coated 40 which faces a liquid spraying section 20, while the liquid is prevented from being coated on the remaining half surface of the columnar object to be coated 40.

In the embodiments described heretofore, the case has been described where the second potential, which is the potential of the coating prevention electrode 30, assumes the potential approximately equal to the first potential, which is the potential of the liquid spraying section 20. However, it is not always necessary for the second potential to assume a potential approximately equal to the first potential.

Provided that, when the potential of the object to be coated 40 is a reference potential, the direction of polarity of the first potential is the same as the direction of polarity of the second potential, the degree of second potential, which is the potential of the coating prevention electrode 30, may be varied corresponding to a range where liquid coating is not desired.

For example, when a variable resistor is additionally provided at an intermediate portion of an electric wire connected to the coating prevention electrode 30, the second potential can be varied by varying a resistance value of the variable resistor. When the second potential is set to a value close to the reference potential, which is the potential of the object to be coated 40, the electric field generated between the coating prevention electrode 30 and the object to be coated 40 is weakened, thus reducing a range where the liquid is not to be coated.

On the other hand, when the second potential is set to a value away from the reference potential, which is the potential of the object to be coated 40, the electric field generated between the coating prevention electrode 30 and the object to be coated 40 is strengthened by a corresponding amount. Accordingly, a range where the liquid is not to be coated can be increased.

However, when the direction of polarity of the first potential is opposite to the direction of polarity of the second potential, such a state means that the coating prevention electrode 30 has the polarity different from the polarity of the liquid spraying section 20 having the first potential. In this case, the electric field is generated between the coating prevention electrode 30 and the liquid spraying section 20 so that the coating prevention electrode 30 becomes a coating target for the liquid sprayed from the liquid spraying section 20. Accordingly, as described above, when the potential of the object to be coated 40 is the reference potential, it is necessary that the direction of polarity of the first potential is the same as the direction of polarity of the second potential.

### Fourth Embodiment

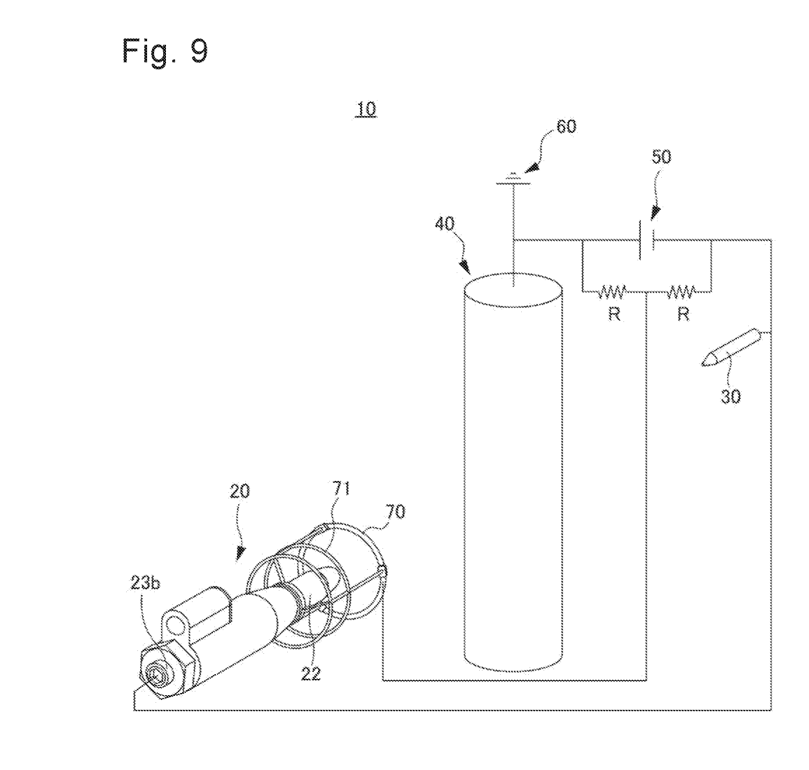

FIG. 9 is a perspective view showing an electrostatic spray apparatus 10 of a fourth embodiment. The fourth embodiment differs from the third embodiment mainly in that the electrostatic spraying apparatus 10 also includes, in addition to the configuration shown in FIG. 8, a proximity electrode holder 71 fixed to an outer periphery of a nozzle 22, and a proximity electrode 70 disposed in the vicinity of the nozzle 22. The proximity electrode holder 71 is made of an insulating material.

A voltage application device 50 applies a voltage to the proximity electrode 70 such that the potential of the proximity electrode 70 assumes a third potential. The third potential is a potential between the reference potential, which is the potential of the object to be coated 40, and the first potential, which is the potential of the liquid spraying section 20. The third potential is set such that a potential difference between the first potential and the third potential assumes a potential difference which allows generation of an electrostatic force by which the liquid is caused to leave from the nozzle 22 in a charged state.

For example, as shown in FIG. 9, the potential (third potential) of the proximity electrode 70 is set to an approximately intermediate value between the reference potential, which is the potential of the object to be coated 40, and the first potential, which is the potential of the liquid spraying section 20, by dividing the voltage, applied between the object to be coated 40 and the liquid spraying section 20, with resistances R.

With the provision of such a proximity electrode 70, leaving and atomization of the liquid from the nozzle 22 are mainly performed between the proximity electrode 70 and the liquid spraying section 20. Accordingly, an atomization state can be maintained even in a state where the object to be coated 40 is not disposed.

Immediately after starting of the atomization, the atomization state may not be stabilized. However, according to the configuration of this embodiment, at timing when the atomization is stabilized, the object to be coated 40 can be conveyed by a conveyor or the like to a position where the liquid is to be sprayed. In other words, it is possible to avoid that the liquid in an unstable atomization state, which occurs immediately after starting of atomization, is coated on the object to be coated 40. Accordingly, occurrence of uneven coating can be suppressed.

The electrostatic spray apparatuses of the present invention have been described heretofore based on the specific embodiments. However, the present invention is not limited to the above-mentioned specific embodiments. For example, in the above-mentioned embodiments, the coating prevention electrode 30 is disposed so as to be directed to the portion of the object to be coated 40 on which the liquid is not to be coated. However, even if the coating prevention electrode 30 is not directed to the portion of the object to be coated 40 on which the liquid is not to be coated, the coating prevention electrode 30 can generate the electric field between the coating prevention electrode 30 and the portion of the object to be coated 40 on which the liquid is not to be coated. Accordingly, the coating prevention electrode 30 can prevent the liquid from being coated on the portion of the object to be coated 40 on which the liquid is not to be coated.

For this reason, the coating prevention electrode 30 can be disposed so as to be directed in any direction where the electric field can be generated between the coating prevention electrode 30 and the portion of the object to be coated 40 on which the liquid is not to be coated. That is, disposing the coating prevention electrode 30 so as to be directed to the portion of the object to be coated 40, on which the liquid is not to be coated, is not essential.

As described above, the present invention is not limited to the above-mentioned embodiments, and the configurations which are obtained by adding appropriate change or modification also fall within the technical scope of the present invention. That is apparent for those skilled in the art from the description of the claims. Further, respective constitutional elements described in the claims and the specification may be arbitrarily combined or omitted within a range where the above-mentioned problems can be at least partially solved, or within a range where the above-mentioned advantageous effect can be at least partially acquired.

### REFERENCE SIGNS LIST

10 electrostatic spray apparatus
20 liquid spraying section
21 body portion
21a liquid supply port
21b liquid flow passage
21c hole portion
21d rear end opening portion
21e female thread structure
22 nozzle
22a distal end edge portion
22b opening portion
23 central rod
23a knob portion
23b electric wire connecting portion
23c male thread structure
23d distal end surface
24 sealing member
30 coating prevention electrode
40 object to be coated
41 front surface
42 rear surface
43, 44 side surface
50 voltage application device
60 ground wire
70 proximity electrode
71 proximity electrode holder
80 Taylor cone

1. An electrostatic spray apparatus for causing a liquid to be coated on an object to be coated, the electrostatic spray apparatus comprising:
a voltage application device;
a liquid spraying section including a nozzle for causing the liquid to leave in a charged state by utilizing an electrostatic force generated by the voltage application device; and
a coating prevention electrode configured to generate an electric field between the coating prevention electrode and a portion of the object to be coated on which the liquid is not to be coated, wherein
the voltage application device is configured to apply a voltage such that, when a potential of the object to be coated is a reference potential, a potential of the liquid spraying section assumes a first potential different from the reference potential, and a potential of the coating prevention electrode assumes a second potential, and
the second potential is a potential different from the reference potential, and a direction of polarity of the second potential is the same as a direction of polarity of the first potential.

2. The electrostatic spray apparatus according to claim 1, wherein
the coating prevention electrode is positioned on a side opposite to the liquid spraying section with respect to an imaginary plane which is orthogonal to a straight line connecting a distal end of the nozzle and the object to be coated with each other with a shortest distance, at a point where the straight line intersects the object to be coated.

3. The electrostatic spray apparatus according to claim 1, wherein
the coating prevention electrode is a rod member made of a conductive material or a semi-conductive material.

4. The electrostatic spray apparatus according to claim 1, wherein
the coating prevention electrode is positioned on a side opposite to the liquid spraying section with respect to the object to be coated.

5. The electrostatic spray apparatus according to claim 1, wherein
the voltage application device applies the voltage between the object to be coated and the liquid spraying section, and between the object to be coated and the coating prevention electrode.

6. The electrostatic spray apparatus according to claim 1, wherein
the first potential and the second potential are approximately equal to each other.

7. The electrostatic spray apparatus according to claim 1, further comprising a proximity electrode disposed in a vicinity of the nozzle, wherein
the voltage application device is configured to apply the voltage such that a potential of the proximity electrode assumes a third potential between the reference potential and the first potential, and
the third potential is set such that a potential difference between the first potential and the third potential assumes a potential difference which allows generation of an electrostatic force by which the liquid is caused to leave from the nozzle in a charged state.
